(19) United States
(12) Patent Application Publication
(10) Pub. No.: US 2021/0299797 A1
(43) Pub. Date: Sep. 30, 2021

(54) SYSTEM AND METHOD FOR CARRYING OUT OPERATIONS ALONG AN ANNULAR JUNCTION PORTION OF A PIPELINE AND LAYING VESSEL COMPRISING SAID SYSTEM

(71) Applicant: SAIPEM S.p.A., San Donato Milanese (IT)

(72) Inventor: Maurizio De Santo, San Donato Milanese (IT)

(21) Appl. No.: 17/262,104

(22) PCT Filed: Jul. 26, 2019
(86) PCT No.: PCT/IB2019/056413

§ 371 Date: Jan. 21, 2021

(30) Foreign Application Priority Data
Jul. 27, 2018 (IT) 102018000007550

(51) Int. Cl. B23K 31/02; B23K 37/02; B23K 37/053

(52) U.S. Cl. CPC B23K 31/027; B23K 37/0223; B23K 2101/10; B23K 37/0533; B23K 37/0282

(57) ABSTRACT

A system for carrying out operations along an annular junction portion of a pipeline is provided with: a frame comprising a C-shaped structure, which is configured to be selectively clamped about a pipeline extending along a longitudinal axis and near an annular junction portion, and at least one driving device arranged along an arc of an annular path and coupled to the structure; a support arm configured to rest on the pipeline and connected to the structure for maintaining the laying plane of the driving device substantially orthogonal to the longitudinal axis; a carriage slideably coupled to the driving device; and at least one operating device configured to carry out operations along the annular junction portion and cantilever supported by said annular segment.

### PRIORITY CLAIM

This application is a national stage application of PCT/IB2019/056413, filed on Jul. 26, 2019, which claims the benefit of and priority to Italian Patent Application No. 102018000007550, filed on Jul. 27, 2018, the entire contents of which are each incorporated by reference herein.

### TECHNICAL FIELD

The present disclosure relates to a system and a method for carrying out operations along an annular junction portion of a pipeline, and a laying vessel comprising said system. In particular, the present disclosure relates to a system and a method for carrying out operations along an annular junction portion of a pipeline for transporting hydrocarbons.

### BACKGROUND

Hydrocarbon transport pipelines are laid on the bed of a body of water by laying vessels, on board of which the pipeline is progressively assembled and then laid as the assembly is carried out.

The laying vessel therefore includes assembly equipment and a launch ramp for the so-called S-laying, or a launch tower for the so-called J-laying. The letters “S” and “J” identify the type of laying in relation to the shape taken by the pipeline during the launch due to the reactions transmitted between the pipeline, the laying vessel, and the bed of the body of water. The so-called S-laying is particularly suitable for laying pipelines in medium shallow water, whereas the so-called J-laying is suitable for laying the pipeline in deep water.

The pipelines are laid on the bed of the body of water by the laying vessel seamlessly. That is, hydrocarbon transport pipelines are composed of pipe sections joined together to cover overall lengths in the order of hundreds of kilometers.

The pipe sections have a unit length, generally 12 meters, and relatively large diameters of between 0.2 meters and 1.5 meters. Each pipe section comprises a steel cylinder; a first single-layer and/or multilayer coating made of a polymeric material, which has the function of protecting the steel pipe; and optionally a second coating made of Gunite or concrete, the function of which is to weigh down the pipeline. In certain applications, the second coating is not necessary and the pipe sections and underwater pipelines do not have a second coating.

The opposite free ends of each pipe section are devoid of the first and the second coating to allow the steel cylinders to be welded together. The end portion without the coating is called a cutback.

On board the laying vessel, the pipe sections are joined to unit-length pipe sections or multiple-length pipe sections (i.e., pipe sections already joined to other pipe sections). In other words, on board the vessel discrete portions of pipes are coupled by joints.

Jointing the pipe sections involves welding the steel cylinders, usually with several welding passes. Once a welding ring has been completed between two steel cylinders, an annular junction portion devoid of the first and the second coating straddles the weld. The annular junction portion is substantially defined by the free ends of the pipe sections and extends axially between two end edges of the first coating.

Several operations are performed on the annular junction portion.

For instance, the annular junction portion must be appropriately treated and coated with at least one protective coating which adheres to the annular junction portion and to the edges of the pre-existing coatings. These operations are generally referred to as “Field Joint Coating”.

The operations on the annular junction portion are carried out on board the laying vessel in a limited number of work stations distributed along a path for the advancing of the pipe sections. Moreover, other different working processes are also carried out in these stations.

Normally, the space available on laying vessels is relatively extremely limited. As a result, the work stations are particularly congested.

### SUMMARY

It is an object of the present disclosure to provide a system for carrying out operations along an annular junction portion of a pipeline, which has a relative small size and requires little manoeuvring space, and at the same time ensures that the operations are carried out with relative precision and reliability.

In accordance with these objects, the present disclosure relates to a system for carrying out operations along an annular junction portion of a pipeline, the system comprising:
a frame comprising a C-shaped structure, which is configured to be selectively clamped about a pipeline extending along a longitudinal axis and near an annular junction portion, and at least one driving device arranged along an arc of an annular path and coupled to the structure;
a support arm configured to rest on the pipeline and connected to the structure for maintaining the laying plane of the driving device substantially orthogonal to the longitudinal axis;
a carriage slideably coupled to the driving device; and
at least one operating device configured to carry out operations along the annular junction portion and cantilever supported by said annular segment.

It should be appreciated that such a configuration enables operations to be carried out in a relatively reliable and precise manner despite other operating devices coexisting in the work station of the laying vessel. That is, the overall dimensions of the system according to the present disclosure are relatively limited.

Moreover, the presence of the support arm enables relatively rapid and stable positioning of the frame on which the carriage supporting the operating device can move.

In greater detail, the support arm is configured to rest on the pipeline on the opposite side of the annular junction portion. In this way, the support arm provides a second support which is offset with respect to the frame in a position that does not hinder the operations carried out by the operating device on the annular junction portion.

In greater detail, the carriage comprises an annular segment slideably coupled to the driving device.

In greater detail, the driving device comprises a plurality of driving elements arranged along the arc of an annular path. In this way, the guide in which the annular segment slides is made up of several elements, such as, in certain embodiments, pairs of rollers and driving pins.

In greater detail, the system comprises a transmission configured to move the carriage with respect to the frame along the arc of an annular path in one direction and in the opposite direction. In this way, the operating device can perform operations around the pipeline in both directions.

In greater detail, the annular segment of the carriage is toothed along the outer surface and the transmission comprises at least one toothed belt; an actuating device; and at least one driving pulley for the toothed belt.

In greater detail, the structure comprises at least two adjustable spacers configured to be arranged in contact with the pipeline. In this way, the structure can be relatively easily adapted to different pipe sizes.

In greater detail, the structure comprises two jaws, which are movable between an operative position wherein the pipeline is clamped and a rest position, and two actuators configured to control the position of the jaws. In this way, the C-shaped structure is clamped by simply actuating the vice actuators.

In greater detail, the support arm comprises a first portion, which is articulated to the structure, and a second portion, which has one end articulated to the first portion and a free end configured to rest on the pipeline.

In certain embodiments, the first portion has an adjustable length. In this way, the support arm can be adapted to different axial lengths of the annular junction portion.

In certain embodiments, the second portion has an adjustable length. In this way, the support arm can be adapted to different diameters of the pipeline.

In greater detail, the carriage comprises a guide, which is orthogonal to the annular segment and cantilever supported with respect to the annular segment, the operating device being movably mounted along the guide. In this way, the operating device operates without relative hindrance and with relative flexibility on the annular junction portion.

In greater detail, the carriage comprises at least one slide slideably engaging the guide and configured to support at least one respective operating device; and at least one actuating device configured to move the slide along the guide. In this way, the movement of the slide enables the operating device to be suitably moved along the annular junction portion.

In greater detail, the system comprises two operating devices, which are cantilever supported by the carriage and arranged at 180° with respect to each other. In this way, processing times are reduced.

In greater detail, the annular segment extends along an arc of a circle greater than 180°. In this way, the annular junction portion can be worked completely with a carriage displacement of as little as 180°.

A further object of the present disclosure is to provide a laying vessel provided with the system described above for carrying out operations along an annular junction portion of a pipeline. In such embodiments, based on the reduced overall dimensions of the system, more space is available on the laying vessel for carrying out other operations as well.

A further object of the present disclosure is to provide a method for carrying out operations along an annular junction portion of a pipeline, comprising:
clamping a C-shaped structure of a frame about a pipeline extending along a longitudinal axis and near an annular junction portion; the frame comprising at least one driving device arranged along an arc of an annular path and coupled to the structure;
resting a support arm coupled to the structure on the pipeline so as to maintain the laying plane of the driving device substantially orthogonal to the longitudinal axis;
moving a carriage slideably coupled to the driving device; and
carrying out operations along the annular junction portion by at least one operating device cantilever supported by the annular segment.

In this way, operations can be carried out in a relatively reliable and precise manner. Moreover, the support arm enables relative rapid and stable positioning of the frame on which the carriage supporting the operating device can move.

In greater detail, clamping the structure comprises moving two jaws of the structure from a rest position to an operating position wherein the pipeline is clamped. In this way, the positioning of the structure is carried out in a relatively simple and quick manner.

In greater detail, the step of resting a support arm on the pipeline comprises regulating the length of a first portion of the support arm articulated to the structure, and regulating the length of a second portion of the support arm, which has one end articulated to the first portion and one free end configured to rest on the pipeline.

In greater detail, the method comprises the step of adjusting the position of the frame with respect to the pipeline. In certain embodiments, the step of adjusting the position of the frame with respect to the pipeline comprises arranging at least two adjustable spacers of the structure into contact with the pipeline and adjusting the length of said spacers on the basis of the dimensions of the pipeline. In this way, the adaptation to different pipe diameters is carried out in a relatively quick and easy manner.

### BRIEF DESCRIPTION OF THE FIGURES

Further features and advantages of the present disclosure will be apparent from the following description of a non-limiting embodiment thereof, with reference to the figures of the accompanying drawings, wherein:

FIG. 1 is a perspective view, with parts removed for clarity, of a system for carrying out operations along an annular junction portion of a pipeline in accordance with the present disclosure;

FIG. 2 is a front view, with parts removed for clarity, of the system in FIG. 1;

FIG. 3 is a perspective view, with exploded parts and parts removed for clarity, of the system in FIG. 1;

FIGS. 4, 5 and 6 are schematic, rear view representations of the system of FIG. 1 in three different configurations;

FIGS. 7, 9, 11, 13, and 14 are schematic, front view representations of the system of FIG. 1 in different operating positions; and

FIGS. 8, 10, and 12 are schematic, side view representations of the system of FIG. 1 in different operating positions.

### DETAILED DESCRIPTION

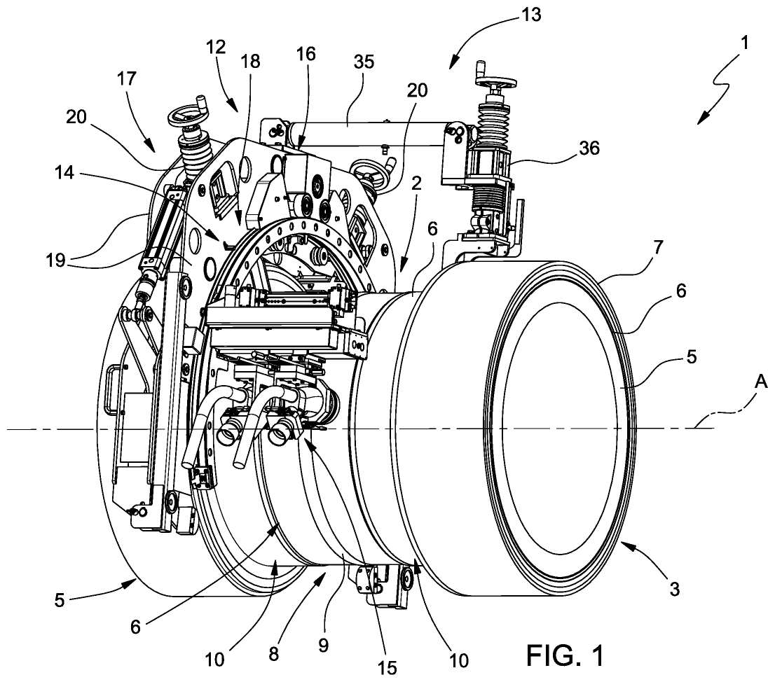

Referring now to the example embodiments of the present disclosure illustrated in FIGS. 1 to 14, in FIG. 1, reference number 1 indicates a system configured to carry out operations along an annular junction portion 2 of a pipeline 3 in accordance with various embodiments of the present disclosure.

The pipeline 3 extends along a longitudinal axis A and comprises at least two cylindrical sections 5 coupled together.

In certain embodiments, the sections 5 are made of steel.

In the non-limiting example described and illustrated herein, the sections 5 are coated with a first polymeric coating 6, which has the function of protecting the steel pipe from corrosion, and with a second optional coating 7 made of Gunite or concrete, the function of which is to weigh down the pipeline.

The coupling area between the two sections 5 defines the annular junction portion 2.

In the annular junction portion 2, there are a central portion 8, without coating and comprising a welding ring 9 between the two sections 5, and two annular side portions 10, arranged at the sides of the first central portion 8, in which, in certain embodiments, only the first coating 6 is present.

The system 1 comprises a frame 12, a support arm 13, a carriage 14, at least one operating device 15, and a transmission 16 configured to advance the carriage 14.

The frame 12 comprises a C-shaped structure 17, and a driving device 18 coupled to the structure 17 and arranged along an arc of a circle.

The structure 17 is configured to be selectively clamped about the pipeline 3 near the annular junction portion 2.

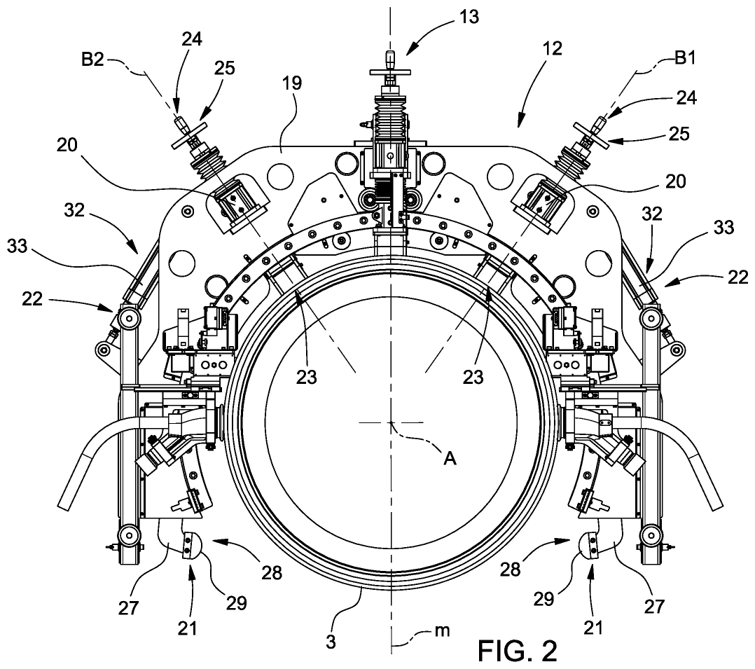

As seen in at least FIG. 2, in the non-limiting example described and illustrated herein, the structure 17 comprises two support plates 19, at least two adjustable spacers 20, at least two movable jaws 21, and at least two actuators 22 configured to control the position of the jaws 21.

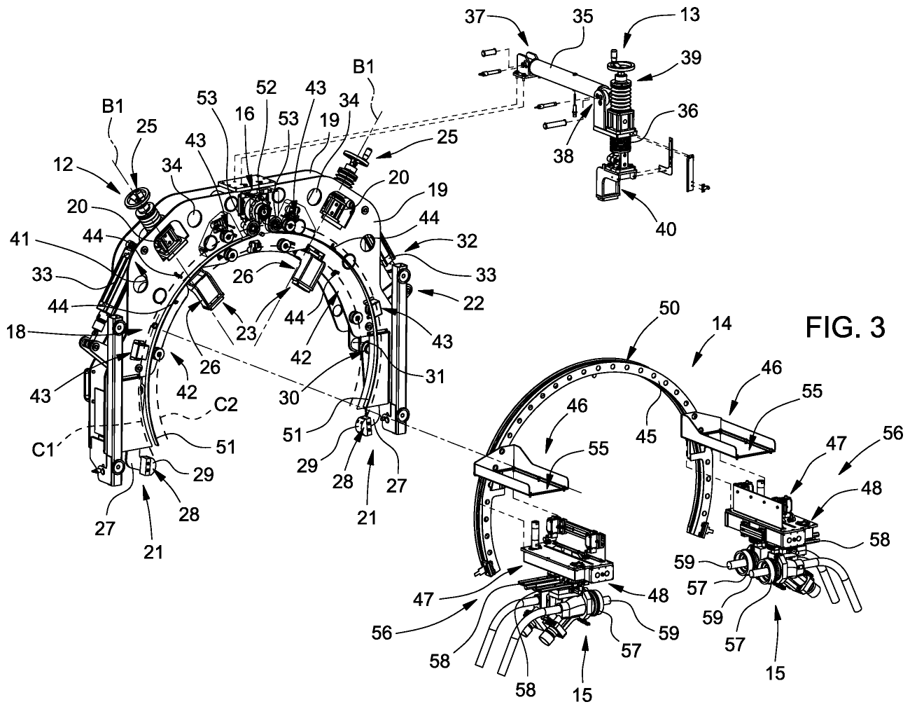

With reference to FIGS. 2 and 3, the support plates 19 are substantially C-shaped and coupled together so as to be spaced apart and parallel to one another. In certain embodiments, the two support plates 19 are substantially identical.

The spacers 20 are housed between the two support plates 19 and arranged in contact with the pipeline 3.

The spacers 20 extend along respective axes B1 and B2 and have an adjustable length.

In certain embodiments, the axes B1 and B2 are arranged along distinct radial directions with respect to the axis A of the pipeline 3.

In certain embodiments, the axes B1 and B2 are symmetrical with respect to a median plane m, which passes through the axis A of the pipeline 3 and substantially divides the pipeline 3 and the support plates 19 in two.

In detail, each spacer 20 is provided with a first end 23 suitable to be placed in contact with the outer surface of the pipeline 3, and with a second end 24 opposite the first end along the respective axis B1 or B2 and provided with adjusters 25 configured to adjust the length of the spacer 20.

In the non-limiting example described and illustrated herein, the first end 23 is suitable to be placed in contact with the outer surface of the second coating 7 of the pipeline 3.

In certain embodiments, the first end 23 is substantially L-shaped so that, in use, the inner surface 26 of the first end 23 can be placed resting on the edge of the second coating 7 facing the annular junction portion 2 (a configuration that is more clearly visible in FIG. 3).

The jaws 21 are coupled to at least one of the support plates 19 and movable between an operating position wherein the pipeline 3 is clamped (configurations schematically shown in FIGS. 5-7, 9 and 11), in which the jaws 21 are arranged in abutment against the outer surface of the pipeline 3, and a rest position (configurations in FIGS. 1, 2, 4), in which the jaws 21 are not in contact with the outer surface of the pipeline 3.

In the non-limiting example described and illustrated herein, each jaw 21 comprises one arm 27 provided with one end 28 that has a support element 29, in certain embodiments, made of a high friction coefficient material (for example rubber), and one end 30 hinged around a pin 31 (partially visible in FIG. 3) coupled to a respective actuator 22.

Each actuator 22 comprises a rod-crank system 32 provided with a piston 33, which, in certain embodiments, is a pneumatic piston.

The actuators 22 are regulated by a control system (not shown in the figures), configured to operate the actuators 22 so as to coordinate the gripping action of both jaws 21.

With reference to FIG. 1, the support arm 13 is coupled to the frame 12 and resting on the pipeline 3. The support arm 13 is configured to provide a further support for the frame 12 offset with respect to the supports defined by the spacers 20.

The support arm 13 is configured so as to maintain the laying plane of the driving device 18 substantially orthogonal to the longitudinal axis A of the pipeline 3.

In detail, the support arm 13 is provided with a first portion 35 and a second portion 36.

With reference to FIG. 3, the first portion 35 is provided with a first end 37 articulated to the structure 17, and with a second end 38 coupled to the second portion 36. The second portion 36 has one part 39 articulated to the second end 38 of the first portion 35, and a free end 40 configured to be placed in contact with the pipeline 3.

The first portion 35 has an adjustable length to enable the axial distance between the structure 17 and the second contact point defined by the free end 40 to be adjusted.

The second portion 36 has an adjustable length to enable the height of the support arm to be adjusted based on the diameter of the pipeline 3 on which the support arm rests.

In the non-limiting example described and illustrated herein, the support arm 13 is configured to rest on the pipeline 3 on the opposite side of the annular junction portion 2. In other words, the structure 17 is clamped to the outer surface of the second coating 7 of a section 5 of the pipeline 3, the support arm 13 extends over the annular junction portion 2, and the free end 40 is placed resting on the outer surface of the second coating 7 of the other section 5 of the pipeline 3.

Another variant (not shown) provides that the support arm 13 is placed resting on the same section 5 of the pipeline 3 to which the structure 17 is clamped.

The frame 12 is also provided with lightening holes 34 made on the support plates 19.

The driving device 18 comprises a plurality of driving elements 42 arranged along an outer face 41 of the structure 17 facing the annular junction portion 2 so as to create a guide in which the carriage 14 can slide.

With particular reference to FIGS. 2 and 3, the driving elements 42 comprise pairs of rollers 43 and driving pins 44.

Each pair of rollers 43 comprises one roller 43 arranged along a first circumferential direction C1, and one roller 43 arranged along a second circumferential direction C2. The first circumferential direction C1 and the second circumferential direction C2 are defined on the basis of the dimensions of the carriage 14 so that the carriage 14 can be arranged between the rollers 43 of each pair and in contact therewith.

In certain embodiments, the rollers 43 of each pair face radial directions.

In certain embodiments, the pairs of rollers 43 are evenly distributed along the arc of a circle.

In certain embodiments, some driving pins 44 are arranged along the first circumferential direction C1 and others along the second circumferential direction C2.

In certain embodiments, the driving pins 44 along the first circumferential direction C1 are radially offset with respect to the driving pins 44 along the second circumferential direction C2.

The carriage 14 is coupled to the driving device 18 in a slidable manner. In particular, the carriage 14 comprises an annular segment 45 coupled to the driving device 18 in a slidable manner, a guide 46 orthogonal to the annular segment and cantilever supported with respect to the annular segment 45, a slide 47 engaging the guide 46 in a slidable manner, and at least one actuating device 48 to move the slide 47 along the guide.

The annular segment 45 is moved by the transmission 16 along the annular path in one direction and in the opposite direction.

In certain embodiments, the annular segment 45 extends along an arc of a circle greater than 180°.

In particular, the annular segment 45 is provided with an outer annular toothed surface 50 suitable for cooperating with the transmission 16. That is, in certain embodiments, the transmission 16 is a toothed belt transmission and comprises at least one toothed belt 51, an actuating device 52 and at least one driving pulley 53 configured to drive the toothed belt 51.

In the non-limiting example described and illustrated herein, the transmission 16 comprises two toothed belts 51 and two driving pulleys 53 actuated by the actuating device 52.

The driving pulleys 53 are arranged side by side in contact with the actuating device 52 and coupled to the respective toothed belts 51 so that when a driving pulley 53 causes one toothed belt 51 to be wound, the other toothed belt 51 is unwound. In this way, the carriage 14 can perform angular movements up to 180° in both directions.

The transmission 16 is coupled to the structure 17, in particular to the outer face 41 of the structure 17.

The guide 46 protrudes in a cantilever fashion orthogonally to the laying plane of the annular segment 45. In other words, since the support arm 13 supports the frame 12 so that the driving device 18 is orthogonal to the axis A of the pipeline 3, the guide 46 extends in a direction parallel to the axis A of the pipeline 3.

The guide 46 has an opening 55 extending in the direction orthogonal to the laying plane of the annular segment 45.

The slide 47 is coupled to one or more operating devices 15 and moves along the opening 55 in the direction orthogonal to the laying plane of the annular segment 45 by a movement device 56.

In the non-limiting example described and illustrated herein, the carriage 14 comprises two guides 46 arranged at 180° with respect to each other, and two movable slides 47 in the respective guides 46, and two operating devices 15 respectively associated with each slide 47.

Each operating device 15 comprises at least one machining head 57, which is coupled to the slide 55.

In certain embodiments, the coupling between the slide 55 and the machining head 57 is a quick-release coupling. In the non-limiting example described and illustrated herein, the coupling between the slide 55 and the machining head 57 is a tightening coupling with a quick-release lever (not shown in the figures).

In certain embodiments, each machining head 57 is coupled to the respective slide 55 so as to be able to perform a movement orthogonal to the axial direction of the pipeline 3 and adjust the distance between the machining head 57 and the pipeline 3. In this way, when the machining head 57 faces the pipeline 3, the machining head 57 can be moved closer to or away from the pipeline 3 based on the type of processing being carried out.

In detail, the coupling between the slide 55 and the machining head 57 can be made so that the adjustment of the distance between the machining head 57 and the pipeline 3 is passive (a solution wherein the distance is adjustable manually and only if necessary) or active (wherein the distance is adjustable automatically). In the non-limiting example described and illustrated herein, the coupling between the slide 55 and the machining head 57 is of the passive type and is achieved by a longitudinal bar 58 of the slide 55 on which the machining head 57 is slidable and fixable when tightened.

Moreover, the machining heads 55 are coupled to the respective slide 55 so that the distance between the machining heads 57 coupled to the same slide 55 is adjustable.

The machining heads 57 may be different depending on the applications.

In the non-limiting example described and illustrated herein, the machining heads 57 are sandblasting heads fed by a feed line in which air and abrasive material ejected by respective nozzles 59 are mixed.

The slide 55 can also support cleaning tools, such as, for example, cleaning wire brushes or omnidirectional wheel cleaning tools. These tools can be associated with brush support devices advantageously provided with automatic mechanisms configured to compensate for ovalization, which keep the brushes in contact with the surface of the pipeline to be cleaned. In use, the positioning of the frame 12 around the pipeline 3 is carried out by an operator using a bridge crane.

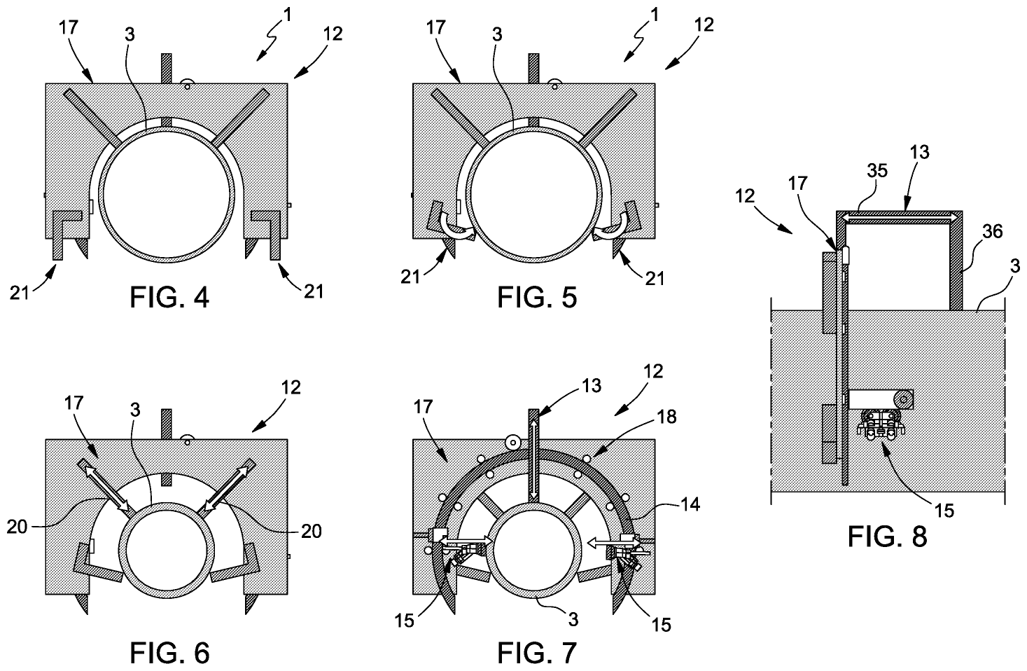

The frame 12 is clamped to the pipeline 3 through actuation of the actuators 22 which move the jaws 21 from the rest position (FIG. 4) to the operating position wherein the pipeline 3 is clamped (FIG. 5), wherein the support elements 29 of the jaws 20 are arranged in abutment against the outer surface of the pipeline 3. The actuators 22 are, in certain embodiments, actuated by an operator by pressing a special key configured to actuate the pistons 33 of the actuators 22.

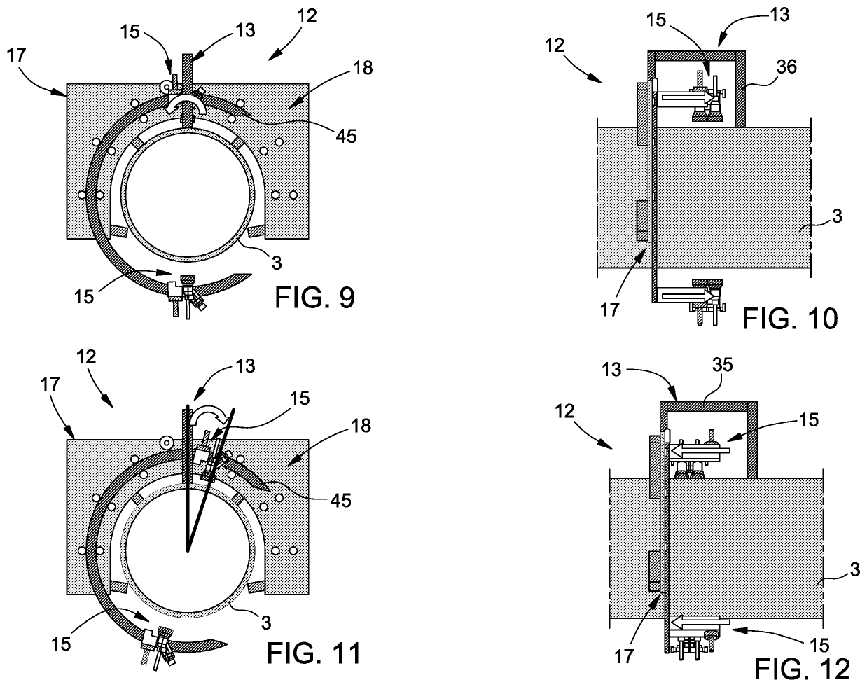

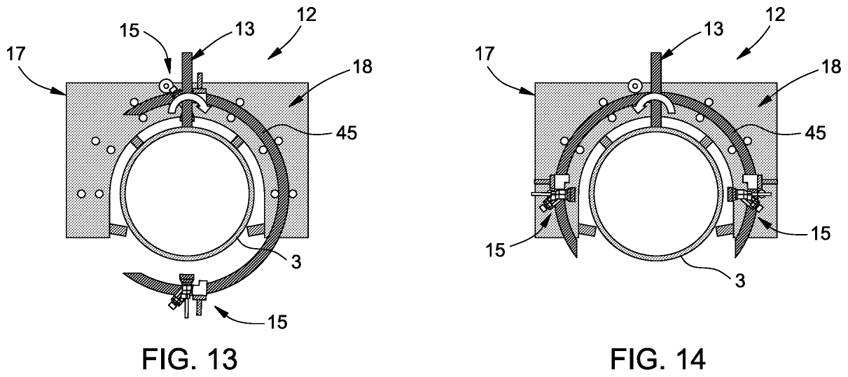

Subsequently, adjusting the position of the frame 12 comprises adjusting the length of the spacers 20 (FIG. 6) and the length of the second portion 36 of the support arm 14 (FIG. 7) based on the diameter of the pipeline 3, and adjusting the length of the first portion 35 of the support arm 13 (FIG. 8) based on the axial dimensions of the annular junction portion 2.

During the steps of positioning, clamping and adjusting the position of the frame 12, the carriage 14 is coupled to the frame 12 in a “rest” position in which the carriage does not protrude from the structure 17 of the frame 12. In this way, the carriage 14 is protected from possible damage.

Once the frame 12 has been positioned, it is possible to proceed with the processing of the annular junction portion 2.

The processing involves a step of positioning the carriage 14 and the machining heads 57 in a “starting” position.

In the non-limiting example described and illustrated herein, the starting position for the carriage 14 is shown in FIG. 9. In this position, the carriage 14 is rotated from the rest position counter-clockwise by approximately 90° so that the machining heads 57 supported by the slides 55 are arranged along the median plane which passes through the axis A and substantially divides the frame 12 in two. The starting position for the machining head 57 is shown in FIG. 12 and corresponds to the position in which the machining heads 57 are arranged proximal to the carriage 14.

It should be understood that the starting position is arbitrary and may be different from those shown in FIGS. 9 and 12.

Once the carriage 14 and the machining heads 57 have been positioned in the “starting” position, the machining heads 57 are actuated and the slide 55 is moved axially towards the position distal to the carriage 14, the carriage 14 is then rotated clockwise by a certain angle (FIG. 11), and the slide 55 is moved axially towards the position proximal to the carriage 14 (FIG. 12).

These steps are repeated until the area of the annular junction portion 2 has been completely covered by the machining heads 57 until the final position shown in FIG. 13 is reached, in which the carriage 14 is rotated 180° with respect to the starting position.

Once the processing is complete, the carriage 14 is repositioned in the rest position (FIG. 14) by a 90° counter-clockwise rotation.

The starting position, the final position, the rest position and the intermediate processing positions are determined automatically based on the presence of endstops set by switches (limit switches).

Finally, the frame 12 is released from the pipeline 3 by moving the jaws 21 to the rest position, and removed from the work station by a bridge crane.

Advantageously, the system according to the present disclosure enables processing on the annular junction portion 2 to be carried out in a relatively short time. That is, the relative lightness of the system 1 according to the present disclosure provides performances with a longitudinal speed of about 150 mm/s and a tangential speed of about 150 mm/s.

Moreover, based on the relative extreme flexibility in terms of adjusting the positioning of the frame 12, the system 1 according to the present disclosure can be adopted on pipelines 3 having different axial lengths of the annular junction portion 2 and/or different diameters and/or different coatings. Additionally, based on the relatively compact and light structure of the system 1 according to the present disclosure, the movement of the parts of the system 1 is relatively safe even in relatively difficult working conditions, with major rolling and pitching movements of the laying vessel.

Handling is also relatively simple and fast (it only requires the use of a bridge crane and basic lashings) and does not interfere with the other equipment present in the work station.

Lastly, the system 1 according to the present disclosure can also be advantageously adopted on pipelines 3 which have a minimum gap, equal to about 0.5 meters between the lower part of the pipeline 3 and the floor.

It is clear that the present disclosure includes further variants that are not explicitly described, without however departing from the scope of protection of the following claims. Accordingly, various changes and modifications to the presently disclosed embodiments will be apparent to those skilled in the art.

The invention claimed is:

1-33. (canceled)

34. A system comprising:
a frame comprising:
a C-shaped structure selectively clampable about a pipeline extending along a longitudinal axis at a distance from an annular junction portion of the pipeline, and
a driving device arranged along an arc of an annular path and coupled to the C-shaped structure;
a support arm positionable on the pipeline and connected to the C-shaped structure to maintain a laying plane of the driving device substantially orthogonal to the longitudinal axis;
a carriage slideably coupled to the driving device; and
an operating device configured to carry out an operation along the annular junction portion of the pipeline, the operating device being cantilever supported by the carriage.

35. The system of claim 34, wherein the support arm is positionable on the pipeline on an opposite side of the annular junction portion with respect to the frame.

36. The system of claim 34, further comprising a transmission configured to move the carriage with respect to the frame along the arc of the annular path in a first direction and in a second, opposite direction.

37. The system of claim 36, wherein the carriage comprises an annular segment slideably coupled to the driving device.

38. The system of claim 37, wherein the annular segment of the carriage is toothed along an outer surface and the transmission comprises: a toothed belt, an actuating device, and a driving pulley configured to mesh with the toothed belt.

39. The system of claim 37, wherein:
the carriage comprises a guide orthogonal to the annular segment and cantilever supported with respect to the annular segment, and
the operating device is movable along the guide.

40. The system of claim 39, wherein the carriage comprises:
a slide slideably engaging the guide and configured to support the operating device; and
an actuating device configured to move the slide along the guide.

41. The system of claim 37, wherein the annular segment extends along an arc of a circle greater than 180°.

42. The system of claim 34, wherein the driving device comprises a plurality of driving elements arranged along the arc of the annular path.

43. The system of claim 42, wherein the plurality of driving elements comprise at least one pair of rollers and at least one driving pin.

44. The system of claim 34, wherein the C-shaped structure comprises at least two adjustable spacers positionable in contact with the pipeline.

45. The system of claim 34, wherein the C-shaped structure comprises:
two jaws movable from an operative position wherein the pipeline is clamped to a rest position;
a first actuator configured to control the position of the first jaw of the two jaws; and
a second actuator configured to control the position of the second jaw of the two jaws.

46. The system of claim 34, wherein the support arm comprises:
a first portion articulated to the C-shaped structure, and
a second portion having one end articulated to the first portion and a free end positionable on the pipeline.

47. The system of claim 46, wherein the first portion has an adjustable length.

48. The system of claim 46, wherein the second portion has an adjustable length.

49. The system of claim 34, further comprising two operating devices cantileverly supported by the carriage and positioned at 180° apart with respect to each other.

50. A laying vessel comprising:
a system configured to carrying out an operation along an annular junction portion of a pipeline extending along a longitudinal axis, the system comprising:
a frame comprising:
a C-shaped structure selectively clampable about the pipeline at a distance from the annular junction portion of the pipeline, and
a driving device arranged along an arc of an annular path and coupled to the C-shaped structure;
a support arm positionable on the pipeline and connected to the C-shaped structure to maintain a laying plane of the driving device substantially orthogonal to the longitudinal axis;
a carriage slideably coupled to the driving device; and
an operating device configured to carry out the operation along the annular junction portion of the pipeline, the operating device being cantilever supported by the carriage.

51. A method comprising:
clamping a C-shaped structure of a frame about a pipeline at a distance from an annular junction portion, wherein the pipeline extends along a longitudinal axis and the frame comprises a driving device arranged along an arc of an annular path and coupled to the C-shaped structure;
positioning a support arm coupled to the C-shaped structure on the pipeline to maintain a laying plane of the driving device substantially orthogonal to the longitudinal axis;
moving a carriage slideably coupled to the driving device; and
carrying out an operation along the annular junction portion by an operating device cantilever supported by the carriage.

52. The method of claim 51, wherein positioning the support arm on the pipeline comprises positioning the support arm on the pipeline on an opposite side of the annular junction portion with respect to the frame.

53. The method of claim 51, wherein moving the carriage comprises advancing the carriage with respect to the frame along the arc of the annular path in one direction and in an opposite direction by a transmission.

54. The method of claim 53, wherein moving the carriage further comprises moving an annular segment of the carriage slideably coupled to the driving device.

55. The method of claim 54, wherein:
the transmission comprises a toothed belt, an actuating device, and a driving pulley configured to mesh with the toothed belt; and
the annular segment of the carriage is toothed along an outer surface.

56. The method of claim 54, wherein:
the carriage comprises a guide orthogonal to the annular segment and cantilever supported with respect to the annular segment; and
the operating device is movably mounted along the guide.

57. The method of claim 56, wherein the carriage comprises:
a slide slideably engaging the guide and configured to support the operating device; and
an actuating device configured to move the slide along the guide.

58. The method of claim 57, wherein moving the carriage further comprises moving the carriage by a predefined angle and subsequently carrying out the operation along the annular junction portion by moving the slide axially along the guide.

59. The method of claim 58, further comprising sequentially repeating the moving of the carriage and the carrying out of the operation until an area of the annular junction portion is complete.

60. The method of claim 58, wherein moving the slide axially comprises moving, based on a position of the carriage, the slide axially towards one of: a distal position with respect to the carriage and a proximal position with respect to the carriage.

61. The method of claim 54, wherein the annular segment extends along an arc of a circle greater than 180°.

62. The method of claim 51, wherein the driving device comprises a plurality of driving elements arranged along the arc of the annular path.

63. The method of claim 51, wherein clamping the C-shaped structure comprises moving two jaws of the C-shaped structure from a rest position to an operating position.

64. The method of claim 51, wherein positioning the support arm coupled to the C-shaped structure on the pipeline comprises regulating a length of a first portion of the support arm articulated to the C-shaped structure and regulating a length of a second portion of the support arm having one end articulated to the first portion and one free end positionable on the pipeline.

65. The method of claim 51, further comprising adjusting a position of the frame with respect to the pipeline.

66. The method of claim 65, wherein adjusting the position of the frame with respect to the pipeline comprises arranging at least two adjustable spacers of the C-shaped structure into contact with the pipeline and adjusting a length of the adjustable spacers based on a dimension of the pipeline.

67. The method of claim 51, wherein the operation along the annular junction portion is carried out by two operating devices cantilever supported by the carriage and positioned at 180° apart with respect to each other.
